(19) United States
(12) Patent Application Publication
(10) Pub. No.: US 2019/0043647 A1
(43) Pub. Date: Feb. 7, 2019

(54) Pull-Resistant Supply Line

(71) Applicant: ZF Friedrichshafen AG, Friedrichshafen (DE)

(72) Inventors: Achim SAUERBREY, Schweinfurt (DE); Thorsten ASSHOFF, Breitenguessbach (DE)

(73) Assignee: ZF Friedrichshafen AG, Friedrichshafen (DE)

(21) Appl. No.: 16/074,467

(22) PCT Filed: Jan. 5, 2017
(86) PCT No.: PCT/EP2017/050190

§ 371 Date: Aug. 1, 2018

(30) Foreign Application Priority Data
Feb. 4, 2016 (DE) 10 2016 201 684.9

(51) Int. Cl. H01F 5/04; F16F 9/46

(52) U.S. Cl. CPC H01F 5/04; H01F 5/02; F16F 9/463

(57) ABSTRACT

A feed line is connected to a coil base body, wherein a pull protection is formed between the feed line and the coil base body. The coil base body has a sleeve for receiving one end of the feed line. The sleeve is part of a retaining connection between the feed line and the coil base body.

### PRIORITY CLAIM

This is a U.S. national stage of application No. PCT/EP2017/050190, filed on Jan. 5, 2017. Priority is claimed on the following application: Country: Germany, Application No.: 10 2016 201 684.9, filed: Feb. 4, 2016, the content of which is/are incorporated herein in its entirety by reference.

### BACKGROUND OF THE INVENTION

The present invention is directed to a pull protection for a feed line in a tubular structural component part.

A piston-cylinder unit having a feed line to an adjustable damping valve is known from US2013248750, the entire content of which is hereby incorporated herein by reference. In this prior art, a multicore cable forms the feed line to a coil.

During the production of the piston-cylinder unit or during assembly, it cannot be ruled out that the connection between the wires of the line and the coil will be detached due to improper handling of the piston-cylinder unit, e.g., carrying by the feed line. So as to be armed against this eventuality as well, the coil has a coating which also encloses the end of the feed line on the coil side. The coating is comparatively expensive to produce because the injection mold must have a sealed outlet for the feed line. During production, the coil must be manually inserted into the injection mold and the cable guided out. Producing a pull protection in this way is laborious particularly in conventional injection molds having a plurality of injection chambers. Often, the coils are already arranged inside a housing in such a way that the coils and the wires never come in contact with an operating medium. Consequently, a coating possibly does more functionally than is required.

### SUMMARY OF THE INVENTION

It is an object of the present invention to provide an alternative pull protection for the feed line.

This object is met in that the coil base body has a sleeve for receiving one end of the feed line, and the sleeve is part of a retaining connection between the feed line and the coil base body.

Because of the sleeve, the coating commonly used heretofore can be dispensed with; at least, a coating need not transmit any traction forces and can therefore be optimized for a sealing function, for example.

In principle the retaining connection can be formed as a positive engagement connection. A positive or form-fit engagement connection can reliably transmit a high traction force and is considered to be comparatively uncritical with respect to manufacturing tolerances of the structural component parts.

Alternatively, the retaining connection can be constructed as a frictional engagement connection. A frictional or friction-fit engagement connection can often be implemented with particularly simple structural component parts.

In one embodiment, the sleeve is formed integral with the coil base body. This connection allows very high forces to be transmitted.

Alternatively, the sleeve can be formed by a separate structural component part. This embodiment facilitates production of the coil base body by injection molding techniques.

In case of a separate sleeve, the sleeve is preferably connected to the coil base body by means of a snap-on connection. A snap-on connection can be closed quickly and reliably and is easily checked for proper fit.

In a particularly simple configuration, the sleeve is constructed as a clamping cylinder.

In a further advantageous configuration, the clamping cylinder is axially slit and has a quantity of clamping hooks. Assembly of the feed line and production of the retaining connection require less expenditure of force than a clamping cylinder without slits.

According to an advantageous embodiment, the sleeve has a conductor channel cover. This construction facilitates the connection of the feed line to the ends of a winding on the coil base body.

The sleeve can also be constructed of multiple parts and the individual component parts form a clamping ring. The component limits of the individual parts can be optimized for injection molding production methods.

Optionally, a retaining ring can be inserted between the sleeve and the feed line. The retaining ring can be radially elastic, e.g., for a frictional engagement connection. The retaining ring is encircled axially in case of a positive engagement connection.

The retaining ring can be additionally secured with respect to the feed line via a supporting ring. When the retaining ring is constructed in the form of an O-ring, the radial retaining force of the retaining ring can be adjusted by way of the position of the supporting ring relative to the retaining ring.

The sleeve can be radially supported at least indirectly at an inner wall of a line receptacle. The support can exist, e.g., only after a certain clearance has been overcome but also by preloading. “Indirectly” means that a transmission ring is used, for example.

In a preferred embodiment, the inner wall is formed by a piston rod of a piston-cylinder unit.

### BRIEF DESCRIPTION OF THE DRAWINGS

The invention will be described more fully referring to the following description of the figures, in which:

FIGS. 1-3 show a frictionally engaging retaining connection between feed line and coil;

FIG. 4 show a variant of FIGS. 1-3;

FIGS. 5-7 show a variant of FIGS. 1-3 with separate multiple-part sleeve;

FIGS. 8-11 show a retaining connection via sleeve and conductor channel cover;

FIGS. 12, 13 show a variant of FIGS. 1-3 with retaining ring;

FIGS. 14, 15 show a positively engaging retaining connection; and

FIGS. 16, 17 show a modification relative to FIGS. 14 and 15.

### DETAILED DESCRIPTION OF THE PRESENTLY PREFERRED EMBODIMENTS

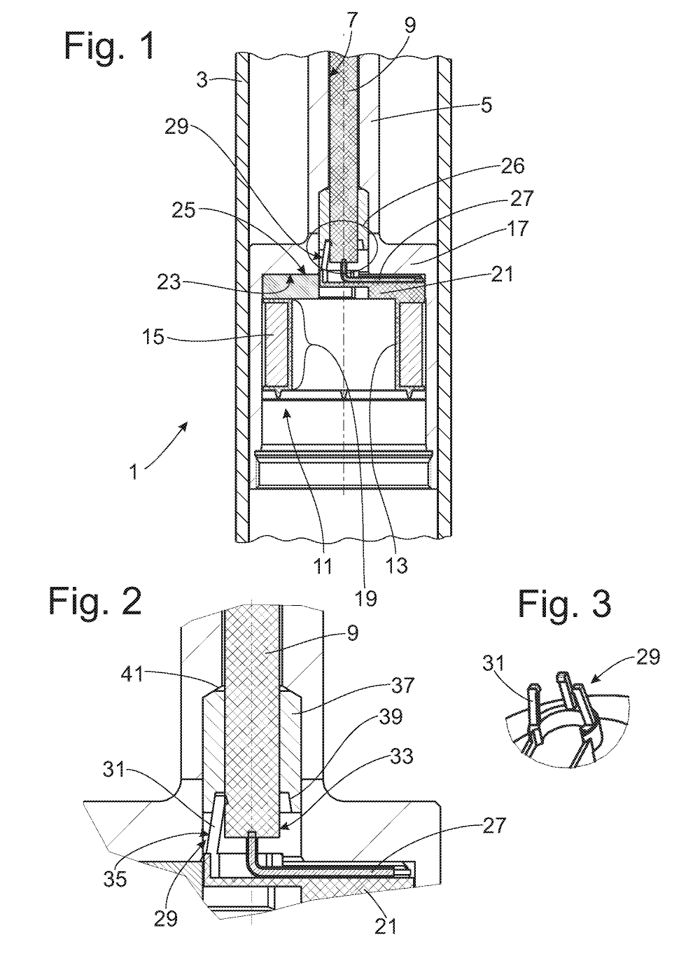

FIG. 1 shows a section of a piston-cylinder unit 1, for example, of an adjustable vibration damper. A piston rod 5 which serves, inter alia, as line receptacle 7 for a feed line 9 of an electric coil 11 is axially movably guided in a cylinder 3. Coil 11 comprises a coil base body 13 and a winding 15 which is shown only schematically. In this embodiment example, a pot-shaped housing 17 is fastened to the hollow piston rod 5 and receives the coil 11. In principle, coil 11 can also be arranged directly inside of the hollow piston rod 5.

The coil base body 13 is preferably produced from plastic by means of an injection molding process and includes a tubular portion 19 for receiving the winding 15 and a cover 21 which is closed at the end. Winding ends, not shown, penetrate the cover 21 up to a cover surface 25 facing in direction of a housing base 23. Individual wires 27 of the feed line 9 rest on the cover surface 25 and are connected to the winding ends.

When FIGS. 2 and 3 are viewed in conjunction, it will be seen that the feed line 9 extends through a sleeve 29 which is constructed in this embodiment example as a clamping cylinder 29. The clamping cylinder 29 is axially slit, and the slits separate clamping hooks 31 from one another. The clamping hooks 31 are radially elastic and lie on an outer lateral surface 33 of the feed line 9. The clamping cylinder 29 is formed integral with the coil base body 13 so that the clamping hooks are likewise made of plastic.

The clamping hooks 31 have an outer conical clamping surface 35 cooperating with a transmission ring 37. The transmission ring 37 also has a conical surface 39 in the form of a countersink.

For assembling the coil/feed line constructional unit, the transmission ring 37 is threaded onto the feed line 9. The end of the feed line 9 is then inserted into the sleeve 29 of the coil base body 13 and connects wires 27 to the ends of the winding 15. The wires 27 lie on the cover surface 25 of the coil base body 13, and the clamping hooks 31 contact the lateral surface 33 of feed line 9 accompanied by radial preloading. In a further assembly step, the transmission ring 37 is slid onto clamping surfaces 35 of the clamping hooks 31 by its conical surface 39 so that the latter deform radially inward on the lateral surface 33. Finally, the open end of the feed line 9 is inserted into the hollow piston rod 5 until the cover surface 25 abuts the housing base 23. The transmission ring 37 abuts an inner shoulder 41 of the hollow piston rod 5. A double-fit between the transmission ring 37 on one side and the cover surface 25 on the other side relative to the piston rod 5 is compensated by the elastic clamping hooks 31.

In the completely assembled state of the coil 11, this coil 11 is fixed inside of the housing 17 such that no detaching movement can act on the transmission ring 37 when there is a pulling load on the feed line 9. The feed line 9 is fixedly anchored inside of the piston rod 5 independently of the wire connection to the winding 15 so that even greater traction forces are absorbed by the frictionally engaging retaining connection 26 between feed line 9 and coil base body 13.

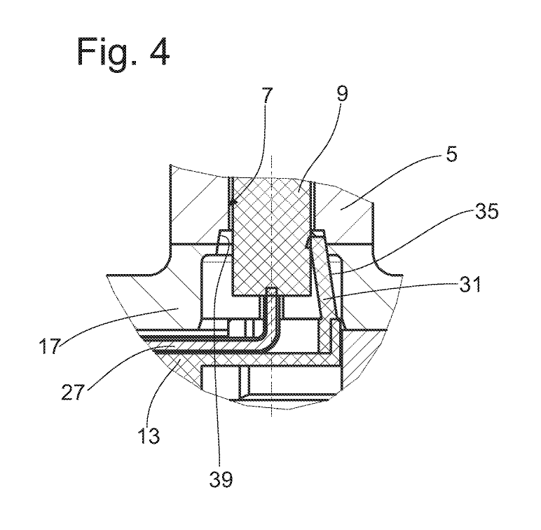

FIG. 4 shows that the function of the transmission ring according to FIG. 2 can also be performed by a conical surface 39 of the line receptacle 7.

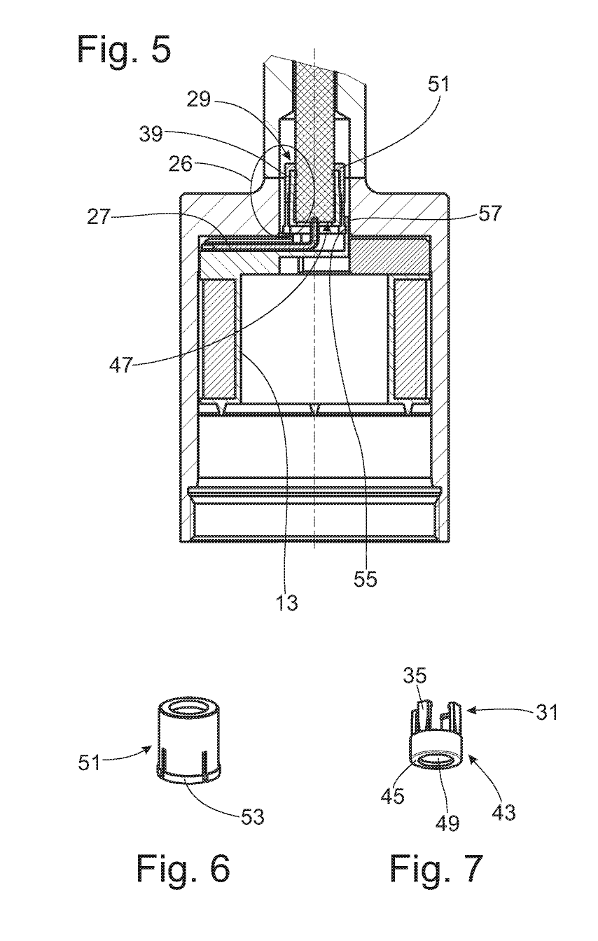

FIGS. 5 to 7 also describe a variant with frictionally engaging retaining connection between sleeve 29 and coil base body 13. In contrast to the embodiment according to FIGS. 1 to 3, the sleeve 29 in this case is formed by a structural component part which is separate from the coil base body 13 and which is in turn formed of multiple parts, and the individual component parts form a clamping ring.

An inner ring 43 as component part of sleeve 29 has individual clamping hooks 31 corresponding to FIGS. 1 to 3. The inner ring has at the end an annular base 45 which determines a stop position at an end face 47 of the feed line 9. The base 45 has a through-opening 49 for the wires 27. A clamping ring 51 as further component part of sleeve 29 has a conical surface 39 corresponding to the transmission ring 37 from FIG. 2. At an end facing in direction of the cover surface 25 of the coil base body 13, the clamping ring 51 has radially an elastic catch 53 which engages in a circumferential groove 55 of the cover surface 25 or a connection piece 57 built on the latter.

The assembly of the feed line 9 starts by sliding on the inner ring 43 and clamping ring 51, where the inner ring 43 abuts the end face 47 of the feed line 9. The feed line 9 is then wired to the winding 15. Subsequently, the clamping ring 51 is slid onto the inner ring 43 by its conical surface 39 on the clamping surface 35 of the clamping hooks 31 such that a frictionally engaging retaining connection is formed between feed line 9 and sleeve 29. Clamping ring 51 is then pressed into coil base body 13 by its catch 53 in order to close the positive engagement connection with the coil base body 13. The open end of the feed line can now be inserted into the hollow piston rod 5 in order to reach the assembly state shown in FIG. 5.

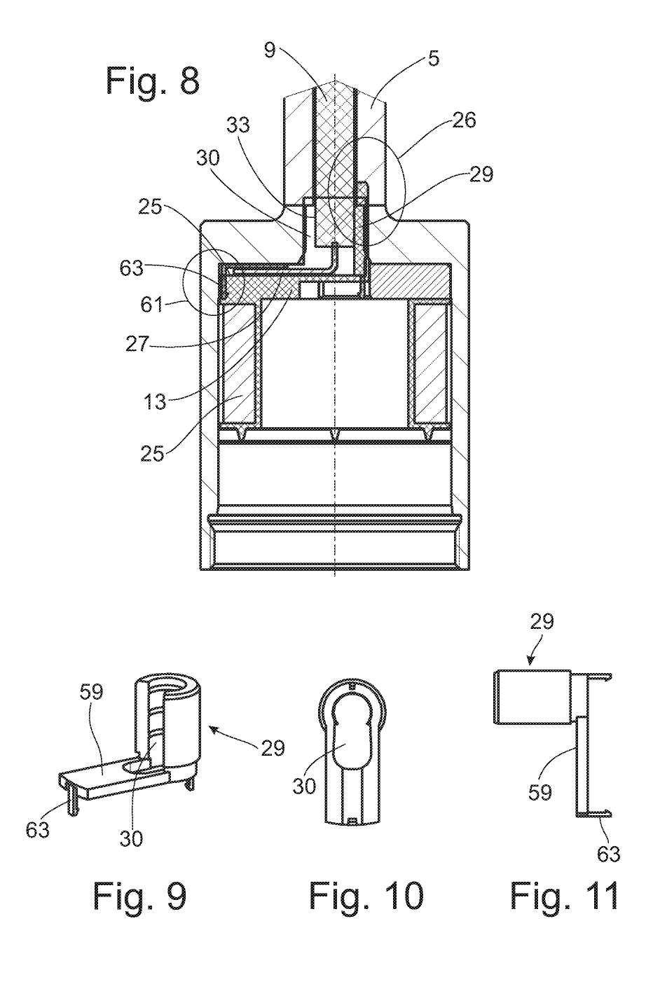

The arrangement according to FIGS. 8 to 11 differs from the two previous embodiments in that the sleeve 29 in the simplest embodiment has only one individual slit 30. Sleeve 29 covers the outer lateral surface 33 by greater than 180° such that an equator of feed line 9 is encircled. The sleeve 29 adjoins a conductor channel cover 59 at right angles which is fastened to the cover surface 25 of the coil base body 13 preferably by a snap-on connection 61. The inner diameter of sleeve 29 is somewhat smaller than the outer diameter of feed line 9. The slit 30 provides for a tolerance compensation for an interference fit. A frictionally engaging retaining connection exists in this area of the sleeve 29 between feed line 9 and sleeve 29.

As will also be discerned from FIG. 8, the individual wires are bent substantially at right angles to the longitudinal axis of piston rod 5. The conductor channel cover 59 fixes the individual wires 27 on the cover surface 25 of coil base body 13. During assembly, feed line 9 is inserted into sleeve 29. In an intermediate position, there is a gap between the end of the sleeve and the wires 27. The wires 27 are bent away and connected to the ends of the winding 15. The conductor channel cover 59 is then pushed in direction of cover surface 25 again together with sleeve 29 and closes the snap-on connection between conductor channel cover 59 and coil base body 13. Catch hooks 63 which engage in the coil base body 13 can be seen in FIGS. 9 and 11. When there is a pulling strain on the feed line 9, the outer lateral surface 33 of feed line 9 exerts a frictional force with sleeve 29, which frictional force acts as a retaining force. In addition, there is a positively engaging connection between the angled wires 27 and the conductor channel cover 59.

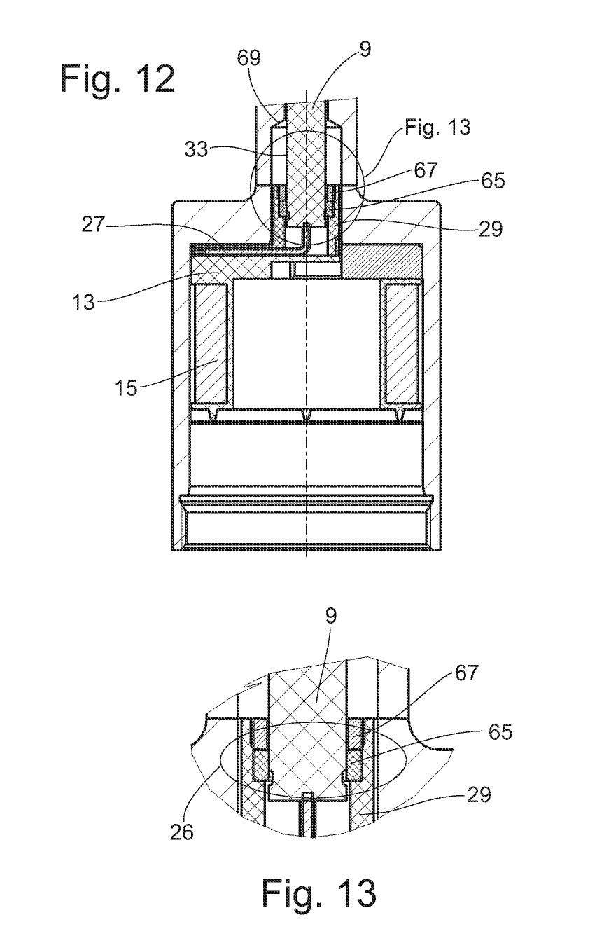

FIGS. 12 and 13 describe a further development of the variant according to FIGS. 8 to 11. The retaining connection additionally has a retaining ring 65 which is formed in this view by an O-ring. Accordingly, a slit according to FIG. 9 is no longer necessary. The O-ring 65 provides for an interference fit between the inner diameter of sleeve 29 and the outer lateral surface 33 of feed line 9. Additionally, a supporting ring 67 can be used, and the preloading of the retaining ring 65 can be adjusted via the supporting ring 67 in that the supporting ring 67 is pressed into sleeve 29 to a varying depth. A comparable effect can be achieved when the retaining ring 65 is directly supported at a shoulder 69 of the hollow piston rod.

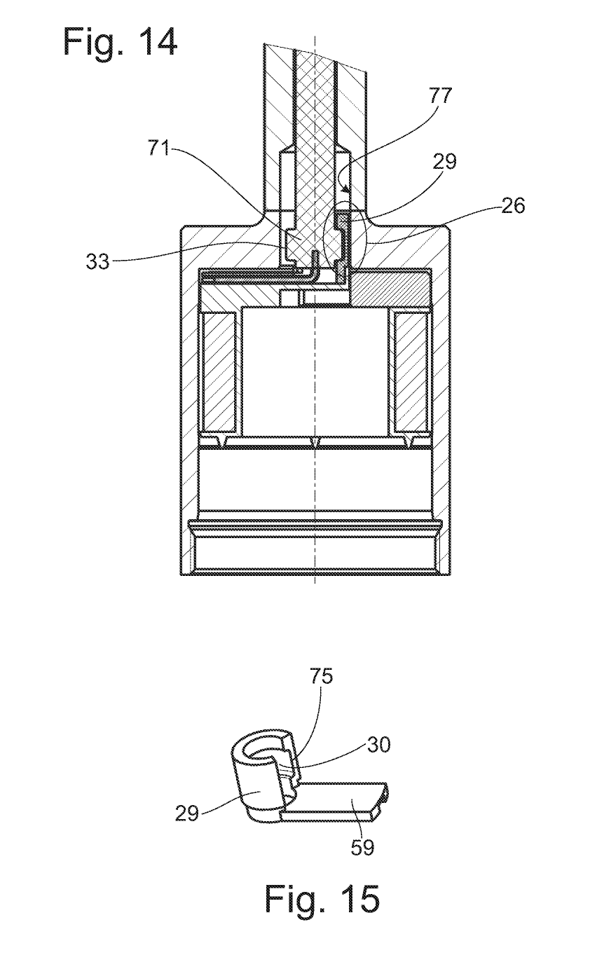

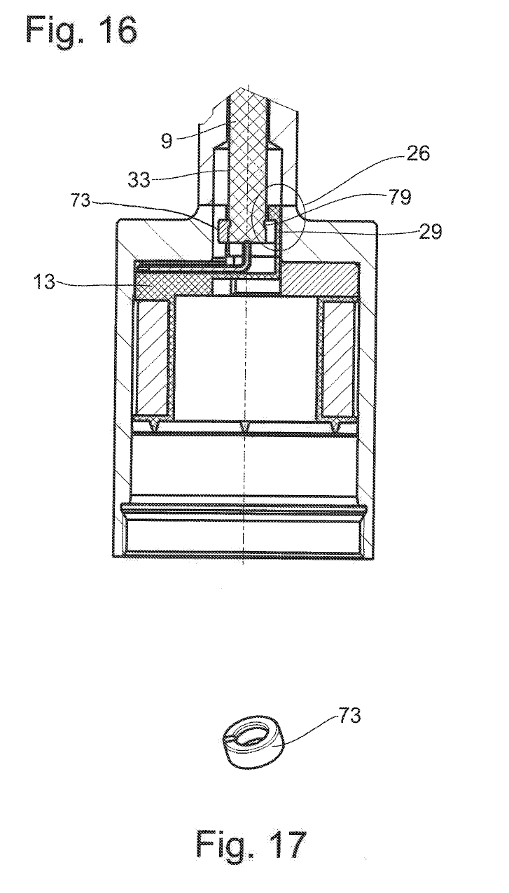

FIGS. 14 and 15 show a variant in which a retaining connection is to be achieved between feed line 9 and coil base body 13 via a positively engaging connection. To this end, the feed line 9 has a thickening 71 which is formed optionally by a partially reinforced sheathing or, as is shown in FIG. 16, by a separate retaining ring 73.

Sleeve 29 has the at least one slit 30 which allows the feed line to be fitted radially into sleeve 29 but also covers more than 180° of the outer lateral surface 33. On the inner side, sleeve 29 has an annular groove 75 for receiving the thickening 71. For assembly, sleeve 29 which also includes a conductor channel cover 59 is buttoned on the feed line 9 in the area of the thickening 71. For this purpose, the sleeve 29 can widen radially within limits. The thickening 71 snaps into the annular groove 75. When the coil 11 together with feed line 9 is fitted into the hollow piston rod 5, an inner wall 77 of the hollow piston rod 5 locks the sleeve 29 in the area of the positively engaging connection between the thickening 71 and the annular groove 75.

The construction according to FIGS. 16 and 17 is identical to the arrangement in FIG. 14 in terms of function. It diverges from it in that the sleeve 29 is formed integral with the coil base body 13, and the thickening for the positively engaging connection is formed by the separate retaining ring 73 which is radially elastic and possibly engages in a groove 79 of the outer lateral surface 33.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1-14. (canceled)

15. A feed line assembly comprising:
a coil base body;
a feed line connected to the coil base body and forming a pull protection between the feed line and the coil base body, the coil base body having a sleeve for receiving an end of the feed line, and wherein the sleeve is part of a retaining connection between the feed line and the coil base body.

16. The feed line assembly according to claim 15, wherein the retaining connection is constructed as a positive engagement connection.

17. The feed line assembly according to claim 15, wherein the retaining connection is constructed as a frictional engagement connection.

18. The feed line assembly according to claim 15, wherein the sleeve is formed integral with the coil base body.

19. The feed line assembly according to claim 15, wherein the sleeve is formed by a separate structural component part.

20. The feed line assembly according to claim 19, wherein the sleeve is connected to the coil base body by means of a snap-on connection.

21. The feed line assembly according to claim 17, wherein the sleeve is constructed as a clamping cylinder.

22. The feed line assembly according to claim 21, wherein the clamping cylinder is axially slit and comprises a quantity of clamping hooks.

23. The feed line assembly according claim 15, wherein the sleeve comprises a conductor channel cover.

24. The feed line assembly according to claim 19, wherein the sleeve is constructed of a plurality of component parts, and wherein the individual component parts form a clamping ring.

25. The feed line assembly according to claim 17, additionally comprising a retaining ring inserted between the sleeve and the feed line assembly.

26. The feed line assembly according to claim 25, additionally comprising a supporting ring and wherein the retaining ring is secured with respect to the feed line assembly via the supporting ring.

27. The feed line assembly according to claim 15, additionally comprising a feed line receptacle having an inner wall and wherein the sleeve is radially supported at least indirectly at the inner wall of the feed line receptacle.

28. The feed line assembly according to claim 27, wherein the inner wall is formed by a piston rod of a piston-cylinder unit.
